(19) United States
(12) Patent Application Publication
(10) Pub. No.: US 2009/0035077 A1
(43) Pub. Date: Feb. 5, 2009

(54) Tool Dust Collector

(76) Inventor: Thomas E. Aley, Cincinnati, OH (US)

Correspondence Address: LAFKAS PATENT LLC, PO Box 43289, CINCINNATI, OH, 45243-0289, US

(21) Appl. No.: 11/833,543

(22) Filed: Aug. 3, 2007

(51) Int. Cl. B23B 47/34

(52) U.S. Cl. 408/67; 15/257.1

(57) ABSTRACT

The present invention includes a device and method for collecting debris discharged from a penetrating surface. The tool dust collector generally employs a substantially flat part with a substantially curved part to form a substantially non-rigid container to be positioned on or near the penetrating surface. The tool dust collector may include adhesive bands to position the device at the penetrating location. The device allows an individual to collect dust and debris safely, efficiently, and without a great deal of preparation.

### CROSS-REFERENCE TO RELATED APPLICATION

Not applicable

### STATEMENT REGARDING FEDERALLY SPONSORED RESEARCH

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND ON THE INVENTION

1. Field of the Invention

The present invention relates generally to a device for collecting dust and debris, more particularly the invention relates to collecting dust and debris released when using a drill or any other tool that creates debris.

2. Description of the Related Art

When penetrating surfaces using a rotary drill or any other tool that creates debris, the material discharged from the surface is normally carried back along the length of the tool and scattered as granular dust or grit in the area directly below the location where the hole is created. In some cases the quantity of debris generated by creating a hole is particularly noticeable. For instance, a 10 mm hole at a 5 cm depth will create nearly 4 cm³ of debris that will be scattered about the immediate area, the majority forming a pile immediately below the hole.

Whilst in many industrial environments such debris would be unnoticeable, this is not the case in the home. Particularly in the do it yourself (DIY) environment, an individual is likely to put down sheeting in the vicinity around the workspace and to vacuum the same immediately after completion to avoid any mess resulting from discharged dust and debris. An individual may also wish to cover or reposition any other furniture and/or decorations that may catch some of the discharged dust and debris. Another concern regarding discharged dust and debris may be, for example, where an individual is installing fixtures or drilling holes near sensitive electronic equipment that cannot easily be moved and the debris may be potentially damaging to the equipment. Thus, it is highly desirable for the dust and debris discharged from a penetrating operation to be completely collected without large amounts of preparation.

Other than using sheeting to catch the majority of the debris, few mechanisms for controlling the spread of such debris are known to be available to small-scale installation operators or to the home DIY market. Complex systems involving vacuums to suck away the dust have been developed over the years, but this usually requires additional vacuum pumps and ducting, and the vacuum is rarely powerful enough to carry all the dust and debris away. For example, several hand tools have been designed to prevent dust from scattering from a drilling surface. However, these tools often require one to use both hands. For example, if a heavy drill is used, it may be difficult for one person to use the tool while drilling. Another safety concern is that the hand tool may require the user's hand to be close to a drill bit when drilling. Thus, it is also highly desirable for dust and debris to be collected in a safe and efficient manner.

### SUMMARY

The various exemplary embodiments of the present invention include a paper collection device for catching debris discharged from a penetrating surface. The device is comprised of a sheet having a top side and a bottom side such that said bottom side is substantially wider than said top side. The sheet also has a front side, a back side, a left side, a right side, and one or more adhesive bands. The sheet may be folded such that said right side of said bottom side of said front side is substantially adjacent to said right side of said top side of said front side and said left side of said bottom side of said front side is substantially adjacent to said left side of said top side of said front side to form a containing means having top and bottom portions.

The various exemplary embodiments of the present invention also include a collection device for catching debris discharged from a penetrating surface. The device is comprised of a substantially flat part having a top side and a bottom side, a front side and a back side, and a left side and a right side, and a containing means having a top side, wherein said containing means is attached to said front side of said flat part and open at the top side of said containing means. In a preferred embodiment, the device may be comprised of plastic.

The various exemplary embodiments of the present invention also include a method of collecting debris discharged from a penetrating surface. The method is comprised of positioning a device having a containing means on said penetrating surface such that said containing means is placed below said penetrating surface, and using a penetrating means at said penetrating surface such that upon discharge from said penetrating surface, at least a substantial amount of said debris is collected in said containing means.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is an illustration of a front side of an exemplary embodiment of the present invention.

FIG. 2 is an illustration of a back side of an exemplary embodiment of the present invention.

FIG. 3 is another illustration of an exemplary embodiment of the present invention.

FIG. 4 is an illustration of a front side of another exemplary embodiment of the present invention.

FIG. 5 is an illustration of a back side of another exemplary embodiment of the present invention.

### DESCRIPTION OF THE REFERENCED MATERIAL

In reference to the drawings, similar reference characters denote similar elements throughout all the drawings. The following is a list of the reference characters and associated element:

10 top side

15 substantially flat part

20 bottom side

25 hole

30 front side

35 containing means

40 left side

45 top of containing means

50 right side

60 adhesive band

65 back side

70 first section

80 second section

90 third section

### DETAILED DESCRIPTION

The drawings show, for purposes of further illustration and understanding, that the various exemplary embodiments of the present invention include a collection device for catching debris discharged from a penetrating surface.

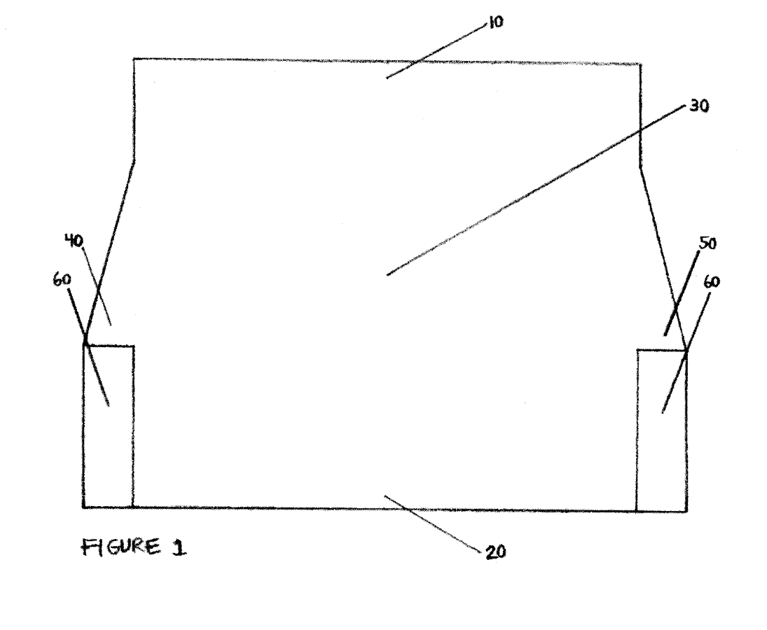

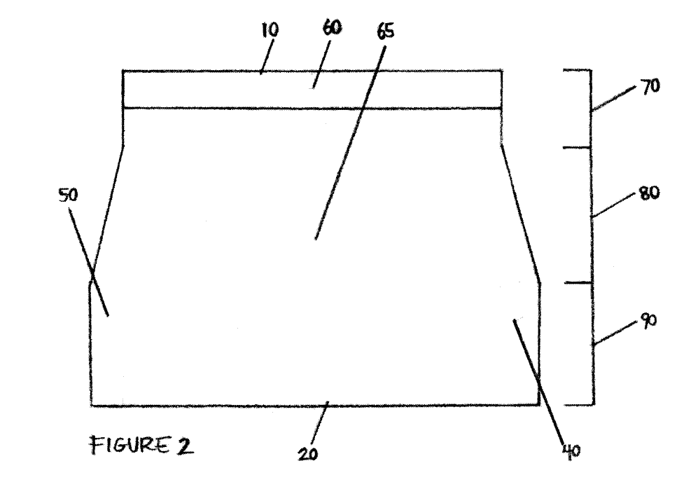

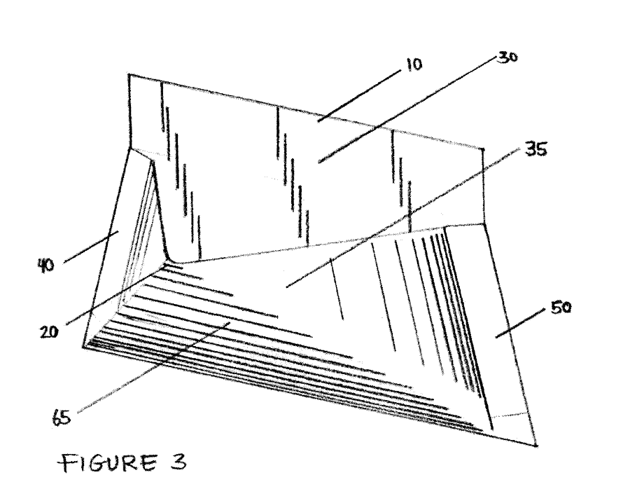

FIG. 1 displays a preferred embodiment of the present invention in the form of a sheet having a top side 10 and a bottom side 20 such that said bottom side 20 is substantially wider than said top side 10. The sheet also has a front side 30 and a back side 65, which is best represented in FIG. 2, a left side 40 and a right side 50, and one or more adhesive bands 60. The sheet may be folded such that the right side 50 of the bottom side 20 of the front side 30 is substantially adjacent to the right side 50 of the top side 10 of the front side 30 and the left side 40 of the bottom side 20 of the front side 30 is substantially adjacent to the left side 40 of the top side 10 of the front side 30 to form a containing means 35 as shown in FIG. 3.

The illustration in FIG. 2 displays the back side 65 of the sheet in FIG. 1, and shows it divided into three sections. In a preferred embodiment, the left side 40 and right side 50 of the first section 70 are substantially parallel. In a preferred embodiment, the left side 40 and right side 50 of the third section go are also substantially parallel. In a preferred embodiment, the left side 40 and right side 50 of the first section 70 are substantially perpendicular to the top side 10, and the left side 40 and right side 50 of the third section go are substantially perpendicular to the bottom side 20.

The illustration in FIG. 3 displays a folded version of the sheet displayed in FIGS. 1 and 2. In a preferred embodiment, the containing means 35 formed allows for the collection of the dust and debris from the penetrating surface. In exemplary embodiments, the top side 10 extends above the containing means 35. In exemplary embodiments, a hole 25 is located on the front side 3o between the top side 10 and the containing means 35, and in a preferred embodiment, the hole 25 is substantially centrally located and sufficiently large enough for an individual to view a desired penetrating location.

In a preferred embodiment, the sheet will have three adhesive bands 60. In a preferred embodiment, the sheet has an adhesive band on each of the left side 40 and the right side 50 on the bottom side 20 of the front side 30 as shown in FIG. 1. In a preferred embodiment, the sheet also has an adhesive band 60 on the back side 65 as shown in FIG. 2. In exemplary embodiments, at least one adhesive band 60 may be used on the back side 65 of the sheet. In a preferred embodiment, one or more of the sheets are releasably adhered to one another by one or more adhesive bands 60. In a preferred embodiment, the sheet displayed in FIGS. 1-3 is made of paper.

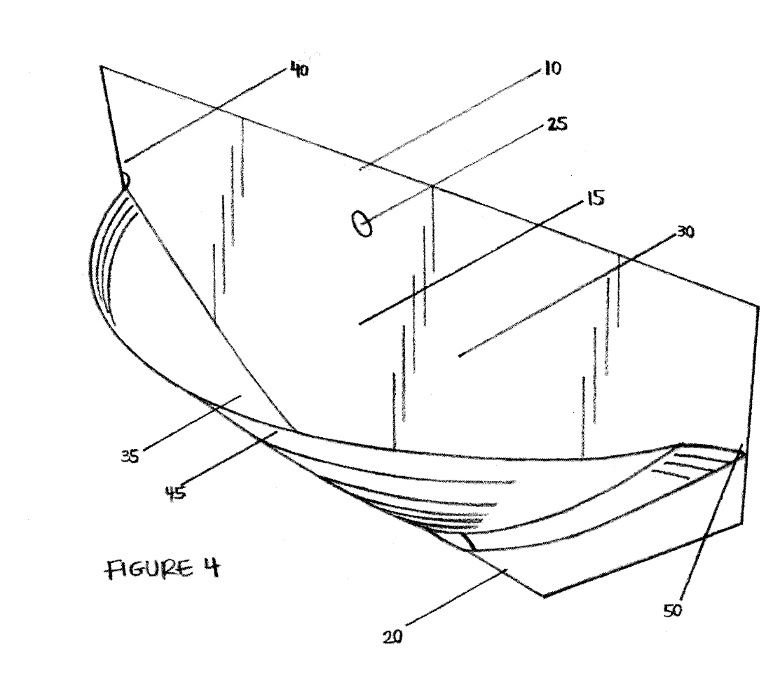

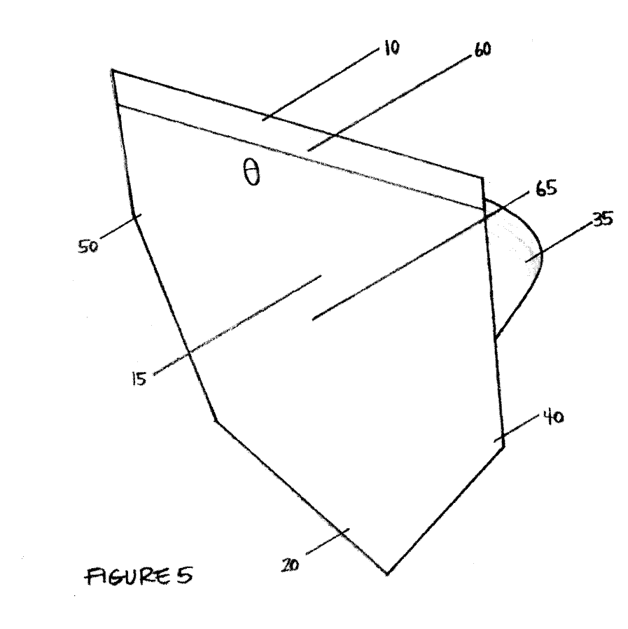

FIG. 4 is an illustration of another embodiment of the present invention, wherein the collection device comprises a substantially flat part 15 having a top side 10 and a bottom side 20, a front side 30 and a back side 65, which is shown in FIG. 5, a left side 40 and a right side 50, and a containing means 35. In an exemplary embodiment, the containing means 35 is substantially funnel-shaped. In an exemplary embodiment, the opening at the top portion of the containing means 35 is substantially semicircularly-shaped. In exemplary embodiments, the collection device can be made of paper, plastic, or cardboard.

In using the present invention, the device can be placed on or near the penetrating surface, preferably under the penetrating location to catch the debris discharged from the created hole. In a preferred embodiment, an adhesive band 60 may be used to maintain the position of the device. In a preferred embodiment, an individual may position the device with the top side 10 up such that a desired penetrating location can be viewed from the hole 25 on the device.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A paper collection device for catching debris discharged from a penetrating surface, the device comprising:
a sheet having a top side and a bottom side such that said bottom side is substantially wider than said top side, a front side and a back side, and a left side and a right side, and one or more adhesive bands, wherein said sheet may be folded such that said right side of said bottom side of said front side is substantially adjacent to said right side of said top side of said front side and said left side of said bottom side of said front side is substantially adjacent to said left side of said top side of said front side to form a containing means having top and bottom portions.

2. The collection device according to claim 1, wherein each of said left side and said right side are respectively comprised of:
a first section connected to said top side, wherein said first section of said right side is substantially parallel to said first section of said left side,
a second section between said first section and a third section, and
said third section connected to said bottom side, wherein said third section of said right side is substantially parallel to said third section of said left side.

3. The collection device according to claim 2, wherein each of said first sections of said left side and said right side are substantially perpendicular to said top side, and wherein each of said third sections of said left side and said right side are substantially perpendicular to said bottom side.

4. The collection device according to claim 3, wherein said top side extends above said containing means.

5. The collection device according to claim 4, wherein a hole is located on said front side between said top side and said containing means such that said hole is substantially centrally located and sufficiently large enough for an individual to view a desired penetrating location.

6. The collection device according to claim 5, wherein said adhesive bands used to create said containing means are located along said left side of said bottom side of said front side and said right side of said bottom side of said front side.

7. The collection device according to claim 6, wherein said back side comprises one or more said adhesive bands to position said containing means on said penetrating surface.

8. The collection device according to claim 1, wherein one or more of said sheets may be releasably adhered to one another by one or more said adhesive bands.

9. The collection device according to claim 1, wherein said containing means is substantially funnel-shaped such that said top portion of said containing means is substantially wider than said bottom portion of said containing means.

10. A collection device for catching debris discharged from a penetrating surface comprising:
a substantially flat part having a top side and a bottom side, a front side and a back side, and a left side and a right side, and
a containing means having a top side, wherein said containing means is attached to said front side of said flat part and open at the top side of said containing means.

11. The collection device according to claim 10, wherein said top side of said back part extends above said containing means.

12. The collection device according to claim 11, wherein a hole is located on said front side between said top side and said containing means such that said hole is substantially centrally located and sufficiently large enough for an individual to view a desired penetrating location.

13. The collection device according to claim 12, wherein one or more adhesive bands is located on said back side of said substantially flat part at or adjacent to said top side.

14. The collection device according to claim 10, wherein said containing means is substantially funnel-shaped such that said top portion of said containing means is substantially wider than said bottom portion of said containing means.

15. The collection device according to claim 10, wherein an opening at said top portion of said containing means is substantially semicircularly-shaped.

16. The collection device according to claim 10, wherein the device is comprised of a material selected from the group consisting of cardboard, paper, and plastic.

17. A method of collecting debris discharged from a penetrating surface comprising the steps of:
positioning a device having a containing means on said penetrating surface such that said containing means is placed below said penetrating surface; and
using a penetrating means at said penetrating surface such that upon discharge from said penetrating surface, at least a substantial amount of said debris is collected in said containing means.

18. The method according to claim 16, wherein said device is a paper collection device for catching debris discharged from a penetrating surface, the device comprising an unfolded sheet having a top side and a bottom side such that said bottom side is substantially wider than said top side, a front side and a back side, and a left and a right side, and one or more adhesive bands, wherein said sheet may be folded such that said right side of said bottom side of said front side is substantially adjacent to said right side of said top side of said front side and said left side of said bottom side of said front side is substantially adjacent to said left side of said top side of said front side to form a containing means having top and bottom portions.

19. The method according to claim 16, wherein said device is a collection device for catching debris discharged from a penetrating surface comprising a substantially flat part having a top side and a bottom side, a front side and a back side, and a left side and a right side, and a containing means having a top side, wherein said containing means is attached to said front side of said flat part and open at the top side of said containing means.
